(19) United States
(12) Patent Application Publication
(10) Pub. No.: US 2026/0236291 A1
(43) Pub. Date: Aug. 13, 2026

(54) INFORMATION PROCESSING APPARATUS, INFORMATION PROCESSING METHOD, INFORMATION PROCESSING PROGRAM, AND DISTRIBUTED CONTROL SYSTEM

(71) Applicant: Yokogawa Electric Corporation, Tokyo (JP)

(72) Inventors: Yoshitaka YOSHIDA, Tokyo (JP); Takeshi TOINAGA, Tokyo (JP)

(21) Appl. No.: 19/151,678

(22) PCT Filed: Feb. 9, 2024
(86) PCT No.: PCT/JP2024/004560

§ 371 Date: Jul. 29, 2025

(30) Foreign Application Priority Data
Feb. 10, 2023 (JP) 2023-019285

(51) Int. Cl. G06F 9/48; G06F 9/50

(52) U.S. Cl. CPC G06F 9/485; G06F 9/505; G06F 2209/5022

(57) ABSTRACT

An information processing apparatus of one of a plurality of control nodes includes: a processor configured to: execute an assigned task; select either one of assigned tasks when a magnitude of a load on the information processing apparatus exceeds a threshold; determine whether the task selected is real-time processing; and request either one of the plurality of control nodes other than the information processing apparatus to execute the task when the task is determined to be real-time processing, and to request a server to execute the task when the task is determined to be not real-time processing.

### TECHNICAL FIELD

The present invention relates to an information processing apparatus, an information processing method, an information processing program, and a distributed control system.

### BACKGROUND ART

Conventionally, a distributed control system (DCS) in which multiple control nodes connected to one another through a network control a plant has been known (for example, refer to Patent Literature 1).

### CITATION LIST

### Patent Literature

### [PTL 1]

Japanese National Publication of International Patent Application No. 2017-511024

### SUMMARY OF INVENTION

### Technical Problem

However, the conventional DCS has a problem that it is sometimes impossible to prevent a control node from becoming overloaded.

For example, as a method of preventing the control node from being overloaded, a method is conceivable in which a management device connected to a network monitors the load of each control node, and performs task reassignment to the control nodes. On the other hand, to implement this method, it is necessary to consider coexistence of monitoring and reassignment functions with other management functions such as task scheduling, and to take measures to prevent conflicts and contradictions and the like between these the functions.

Moreover, for example, as a method to prevent the control nodes from becoming overloaded, a method of configuring each control node to function as a management device is conceivable. On the other hand, to implement this method, it is necessary to incorporate functions equivalent to the management device in all of the nodes.

As described, in the conventional DCS, it is not easy to implement a method to prevent the control nodes from becoming overloaded described above.

On one aspect, it is an object to prevent a control node of a DCS from becoming overloaded.

### Solution to Problem

According to one aspect of embodiments, an information processing apparatus of one of a plurality of control nodes includes: an executing unit configured to execute an assigned task; a selecting unit configured to select either one of assigned tasks when a magnitude of a load on the information processing apparatus exceeds a threshold; a determining unit configured to determine whether the task selected by the selecting unit is real-time processing; and a requesting unit configured to request either one of the plurality of control nodes other than the information processing apparatus to execute the task when the determining unit determined that the task is real-time processing, and to request a server to execute the task when the determining unit determined that the task is not real-time processing.

According to one aspect of embodiments, an information processing method that is performed by a computer of one of a plurality of control nodes, the method includes: executing an assigned task; selecting either one of assigned tasks when a magnitude of a load on the computer exceeds a threshold; determining whether the selected task is real-time processing; and requesting either one of the plurality of control nodes other than the computer to execute the task when the determining unit determined that the task is real-time processing, and requesting a server to execute the task when the determining unit determined that the task is not real-time processing.

According to one aspect of embodiments, an information processing program causes a computer to execute a process comprising: executing an assigned task; selecting either one of assigned tasks when a magnitude of a load on the computer exceeds a threshold; determining whether the selected task is real-time processing; and requesting either one of the plurality of control nodes other than the computer to execute the task when the determining unit determined that the task is real-time processing, and requesting a server to execute the task when the determining unit determined that the task is not real-time processing.

According to one aspect of embodiments, a distributed control system includes: a plurality of control nodes that are connected to one another; and a server that is connected to the control nodes, wherein each of the control nodes includes an executing unit configured to execute an assigned task; a selecting unit configured to select either one of assigned tasks when a magnitude of a load on its own device exceeds a threshold; a determining unit configured to determine whether the task selected by the selecting unit is real-time processing ; and a requesting unit configured to request either one of the plurality of control nodes other than the control node itself to execute the task when the determining unit determined that the task is real-time processing, and to request the server to execute the task when the determining unit determined that the task is not real-time processing.

### Advantageous Effects of Invention

According to one embodiment, it is possible to prevent control nodes of a DCS from becoming overloaded.

### BRIEF DESCRIPTION OF DRAWINGS

FIG. 1 is a diagram illustrating a configuration example of a distributed control system according to a first embodiment.

FIG. 2 is a diagram illustrating a configuration example of a control node according to the first embodiment.

FIG. 3 is a diagram illustrating a configuration example of a server according to the first embodiment.

FIG. 4 is a diagram explaining an offload of a task.

FIG. 5 is a diagram explaining an offload of a task.

FIG. 6 is a flowchart illustrating a flow of processing of the control node.

FIG. 7 is a diagram explaining a hardware configuration example.

### DESCRIPTION OF EMBODIMENTS

Hereinafter, an embodiment of an information processing apparatus, an information processing method, an information processing program, and a distributed control system disclosed in the present application will be explained in detail with reference to the drawings. The embodiment explained herein is not intended to limit the present invention. Moreover, identical reference symbols are assigned to identical components, and duplicated explanation is omitted as appropriate. Furthermore, respective embodiments can be combined within a range not causing a contradiction. Furthermore, a control node is one example of the information processing apparatus.

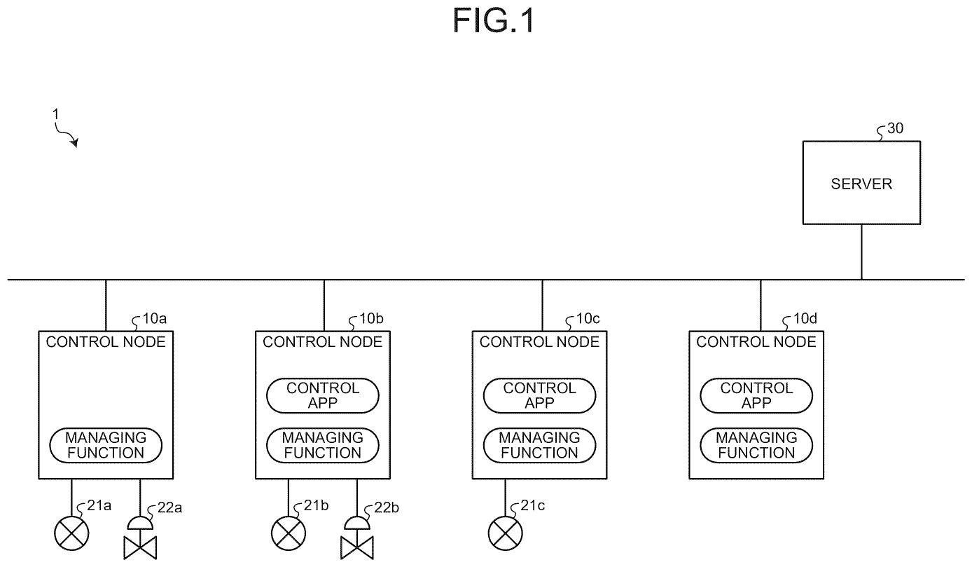

A configuration of a distributed control system according to a first embodiment will be explained by using FIG. 1. FIG. 1 is a diagram illustrating a configuration example of the distributed control system according to the first embodiment.

As illustrated in FIG. 1, a distributed control system 1 includes a control node 10a, a control node 10b, a control node 10c, a control node 10d, a field device 21a, a field device 22a, a field device 21b, a field device 22b, a field device 21c, and a server 30.

In the following explanation, the respective control nodes may be called control node 10 without distinguishing them. Moreover, in the following explanation, the respective field devices may be called field device 20 without distinguishing them.

The number of the control node 10 and the field device 20 included in the distributed control system 1 is not limited to the one illustrated in FIG. 1. Moreover, to each of the control nodes 10, one or more field devices 20 may be connected, or may be configured without connecting the field device 20.

The field device 20 is installed in a plant. The plant is, for example, an oil plant, a petrochemical plant, a chemical plant, and a gas plant. These plant produces products such as liquefied natural gas (LNG), resins (plastics, nylon, and the like), and chemical products when the plant is in operation.

Moreover, the plant has factory facilities, machinery facilities, production facilities, power generation facilities, storage facilities, and facilities at a wellhead for extracting oil, natural gas, and the like. Additionally, in the plant, equipment for producing products is installed.

The field device 20 acquires information relating to a condition of the plant. For example, the field device 20 is a temperature sensor, a pH sensor, a velocity sensor, an acceleration sensor, a pressure sensor, a gas concentration sensor, a device that to detect valve positions, a device to detect a status (on or off) of a switch, and the like.

The field device 20 transmits data indicating sensor values or detection results to the control node 10 in a predetermined communication protocol.

The control node 10 executes assigned tasks. The task corresponds to a part of or all of operations that occur during execution of an application. For example, the task is a function included in an application, a function block (FB), a function module, and the like. The task may be one that uses data received from the field device 20.

A control application (APP) illustrated in FIG. 1 is an application to execute a task. In the control node 10a, the control node 10b, the control node 10c, and the control node 10d, a common control application has been installed.

Furthermore, the control node 10a, the control node 10b, the control node 10c, and the control node 10d have a managing function. The managing function is a function to prevent the control node 10 from becoming overloaded. Details of the managing function will be described later.

The server 30 is connected to the control node 10 through a network. As illustrated in FIG. 1, the server 30 may be configured not to be connected directly to the field device 20. The server 30 has higher processing capabilities compared to the control node 10 (for example in operation speed of a processor, memory capacity, disk I/O speed, and data communication speed).

The distributed control system 1 is one example of a process control system. In a process control system, real time processing and non-real-time processing are performed. Moreover, the task executed by the control node 10 is categorized into either one of the real-time processing and the non-real-time processing.

The real-time processing includes execution of a control application, transmission and reception of data between control nodes, and the like. For example, the real-time processing is processing to control the field device 20 based on information acquired from the field device 20 (for example, PID control).

The non-real-time processing is processing relating to system monitoring, field device management, quality management, advanced control, and the like. For example, the non-real-time processing is processing that is performed by using data collected over a certain period from the control nodes 10. In this case, the control node 10 converts data acquired from the field device 20 into a format suitable for following processing, to output.

Moreover, the non-real-time processing includes processing that requires a certain level of arithmetic capacity, and processing that requires a specialized device, such as graphics processing unit (GPU).

In the conventional DCS, the real-time processing has been performed by a controller (corresponding to, for example, the control node 10). Moreover, in the conventional DCS, the non-real-time processing has been performed by a device (corresponding to, for example, the server 30 of the present embodiment) different from the controller, such as a PC and a server.

Conversely, in recent years, open process control systems, such as open process automation (OPA) advocated by the Open Process Automation Forum have been proposed (reference literature: https://www.yokogawa.com/us/solutions/featured-topics/open-process-automation/). In the OPA system, processing hierarchy becomes flat, and the real-time processing is required even in a device different from the controller, such as a server. Meanwhile, a case of performing the non-real-time processing on the control node also occurs.

The control node in the OPA system may be called distributed control node (DCN). Moreover, the control node of the present embodiment is, for example, a distributed control node (DCN) in the OPA system.

For example, in the example in FIG. 1, the server 30 is located physically or on the network at a distance from the plant or the field device 20 compared to the control node 10. For example, when data acquired from the field device 20 is used in the non-real-time processing, it is more advantageous in terms of data transfer time or the like if the processing is performed by the control node 10 rather than by the server 30. As described, by performing the non-real-time processing by the control node 10, edge computing is enabled.

On the other hand, when the non-real-time processing is performed by the control node 10, there is an issue that a load on the control node 10 becomes heavier. However, according to the managing function of the present embodiment, even when the control node 10 performs both the real-time processing and the non-real-time processing, it is possible to prevent the control node 10 from becoming overloaded.

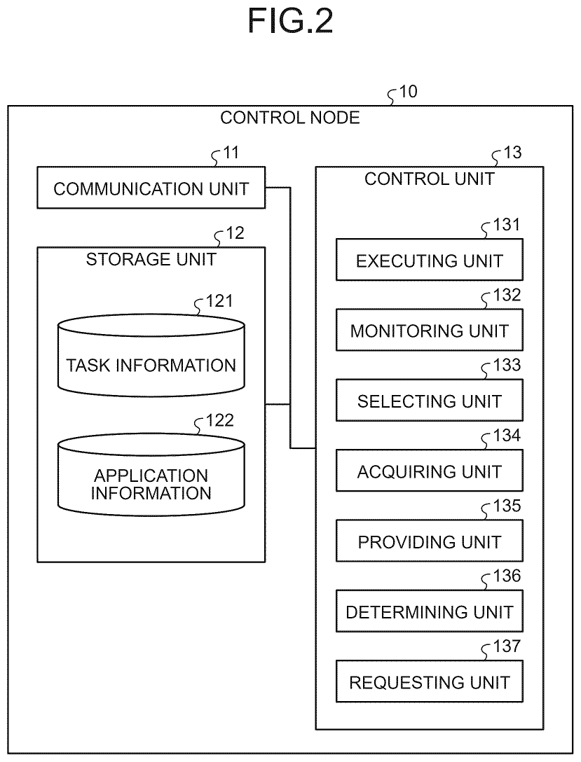

A configuration of the control node 10 will be explained by using FIG. 2. FIG. 2 is a diagram illustrating a configuration example of the control node according to the first embodiment. As illustrated in FIG. 2, the control node 10 includes a communication unit 11, a storage unit 12, and a control unit 13.

The control node 10a, the control node 10b, the control node 10c, and the control node 10d have the configuration illustrated in FIG. 2. However, the distributed control system 1 may include a control node having a configuration different from the configuration illustrated in FIG. 2.

The communication unit 11 performs communication of data with other devices. For example, the communication unit 11 is a communication interface. The communication 11 performs communication with the field device 20 and the server 30.

Moreover, the communication unit 11 performs communication of data with the control nodes 10 other than itself. Thus, communication among the control nodes is achieved. For example, the control node 10 other than its own device for the control node 10b includes the control node 10a, the control node 10c, and the control node 10d. In this case, the control node 10b can perform communication with the control node 10a, the control node 10c, and the control node 10d.

In the following explanation, the control node 10 other than its own device may be referred to as, simply, other control nodes 10, or different control nodes 10.

The storage unit 12 stores various kinds of data, various kinds of programs executed by the control unit 13, and the like. For example, the storage unit 12 is a storage device, such as a memory and a hard disk. This storage unit 12 stores various kinds of data that is generated by processing performed by the control node 10, such as data acquired during various kinds of processing performed by the control unit 13 and processing results acquired as a result of performing various kinds of processing.

The storage unit 12 stores task information 121 and application information 122.

The task information 121 is a list of tasks assigned to the control node 10. The tasks are assigned in a unit of applications, functions, function blocks, function modules, and the like. Moreover, the tasks may be assigned through the server 30, or may be assigned through a device other than the server 30.

The application information 122 is data, such as a program necessary for executing an application. For example, the application information 122 is a packaged application.

The control unit 13 is a processing unit that controls the entire control node 10. The control unit 13 is implemented by, for example, a processor or the like. The control unit 13 includes a executing unit 131, a monitoring unit 132, a selecting unit 133, an acquiring unit 134, a providing unit 135, a determining unit 136, and a requesting unit 137.

The executing unit 131 performs tasks. For example, the executing unit 131 loads an application program corresponding to a task indicated in the task information 121 from the application information 122. The executing unit 131 performs operation according to the loaded program.

The monitoring unit 132 monitors a load of the control node 10. For example, the monitoring unit 132 monitors either one or more of a CPU usage rate, a memory usage rate, of disk I/O volume, and a data communication amount of the control node 10 as its load.

Factors of variations in load on the control node 10 include excessive generation of alarms due to abnormalities of the field device and in processing, changes in control operations resulting from addition of a new field device 20, and increased monitoring from a human machine interface (HMI), and the like.

The selecting unit 133 selects either one of assigned tasks, that is, tasks indicated in the task information 121, when the load on its own device exceeds a threshold. For the task thus selected, another device may be requested to execute it.

For example, the selecting unit 133 selects a task, the processing load of which is greatest out of the tasks indicated in the task information 121. In this case, an estimated magnitude of processing load for each task is stored in the task information 121 in advance. The selecting unit 133 acquires the magnitude of processing load of each task by referring to the task information 121.

The acquiring unit 134 acquires information indicating whether the task selected by the selecting unit 133 can be executed by the other control node 10. The information indicating whether the task can be executed may be a magnitude of load on the other control node 10.

The providing unit 135 provides information indicating whether execution of a specified task is possible, to the other control node 10.

The determining unit 136 determines whether the task selected by the selecting unit 133 satisfies a condition. For example, the determining unit 136 determines whether the task is real-time processing or non-real-time processing.

Moreover, in the task information 121, information indicating whether a task is real-time processing or non-real-time processing for each task may be stored in advance. In this case, the determining unit 136 can determine whether each task is the real-time processing or the non-real-time processing by referring to the task information 121.

The requesting unit 137 requests the other control node 10 or the server 30 to perform the task selected by the selecting unit 133. The requesting unit 137 requests the other control node 10 (example of a first device) to perform the task when the task satisfies a condition, and requests the server 30 (example of a second device) to perform the task when the task does not satisfy the condition.

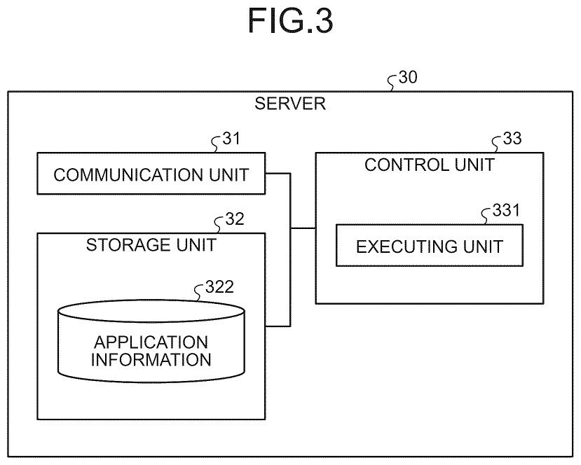

A configuration of the server 30 will be explained by using FIG. 3. FIG. 3 is a diagram illustrating a configuration example of a server according to the first embodiment. As illustrated in FIG. 3, the server 30 includes a communication unit 31, a storage unit 32, and a control unit 33.

The communication unit 31 performs communication of data with other devices. For example, the communication unit 31 is a communication interface. The communication unit 31 performs communication with the control node 10.

The storage unit 32 stores various kinds of data, various kinds of programs executed by the control unit 33, and the like. For example, the storage unit 32 is a storage device, such as a memory and a hard disk. This storage unit 32 stores various kinds of data that is generated by processing performed by the server 30, such as data acquired during various kinds of processing performed by the control unit 33 and processing results acquired as a result of performing various kinds of processing.

The storage unit 32 stores application information 322.

The application information 322 is data, such as a program necessary for executing an application. For example, the application information 122 is a packaged application.

The control unit 33 is a processing unit that controls the entire server 30. The control unit 33 is implemented by, for example, a processor or the like. The control unit 33 includes a executing unit 331.

The executing unit 331 executes a task. For example, an application program corresponding to a task for which execution is requested by the control node 10 is loaded from the application information 122. The executing unit 331 executes the loaded program.

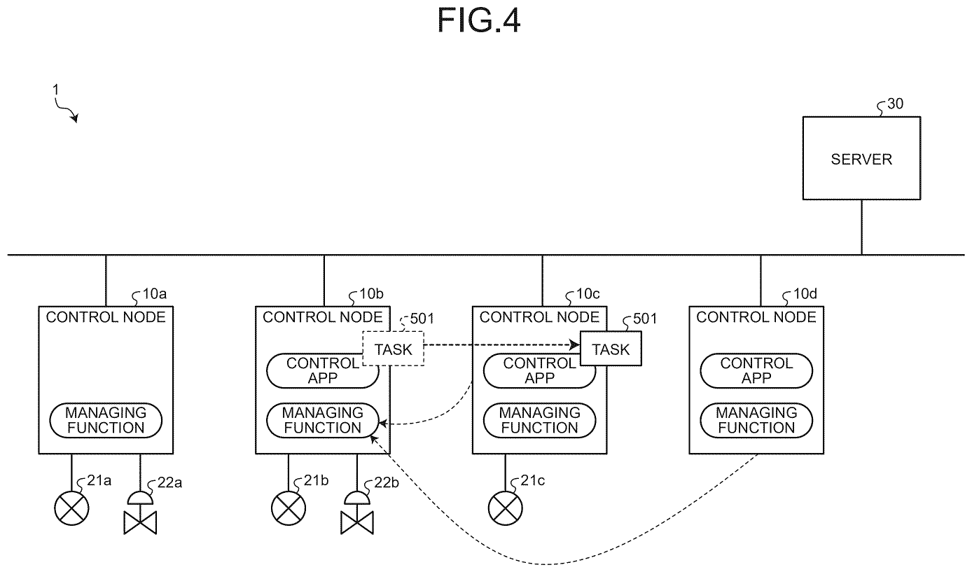

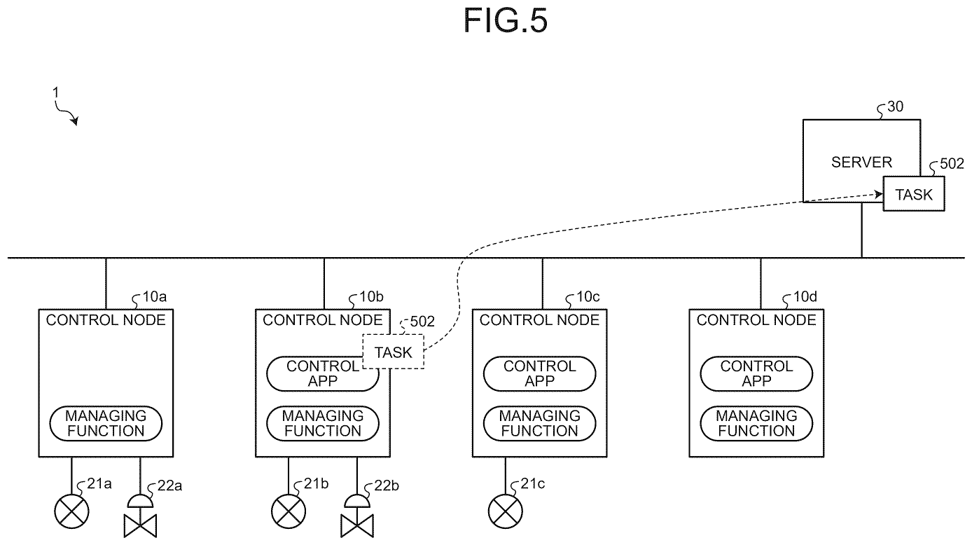

Returning back to FIG. 2, the requesting unit 137 determines a device to be requested to perform the task according to a determination result by the determining unit 136. Moreover, requesting execution of a task to another device is called offload. FIG. 4 and FIG. 5 are diagrams explaining the offload of a task.

When it is determined that the task selected by the selecting unit 133 is the real-time processing by the determining unit 136, the requesting unit 137 requests the other control node 10 to execute the task as illustrated in FIG. 4.

When it is determined that the task selected by the selecting unit 133 is the non-real-time processing by the determining unit 136, the requesting unit 137 requests the server 30 to execute the task as illustrated in FIG. 5.

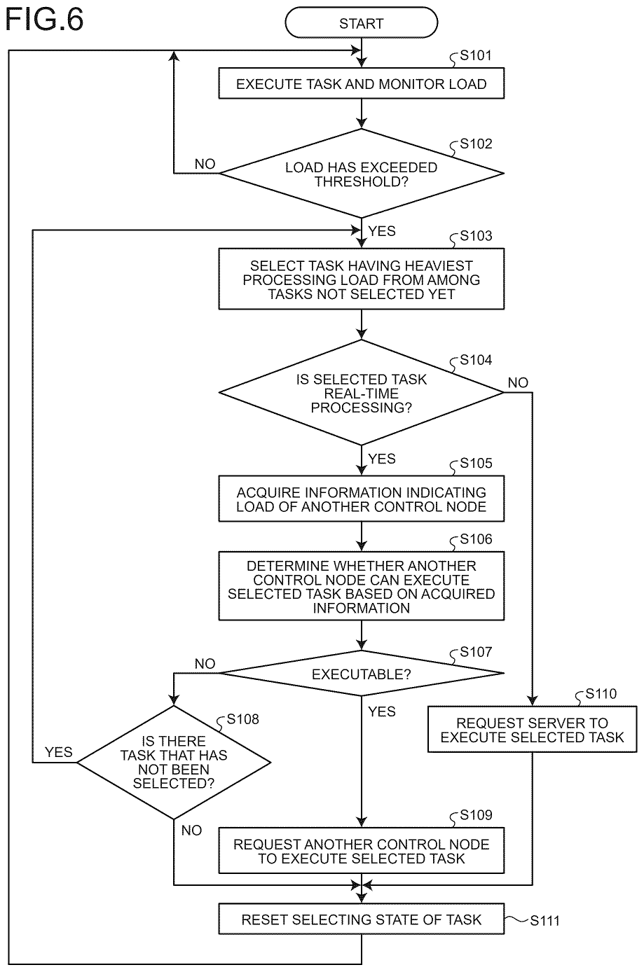

A flow of processing of the control node 10 will be explained by using FIG. 6. FIG. 6 is a flowchart illustrating a flow of processing performed by the control node.

In this example, it is explained as the control node 10b is the primary entity for processing. Furthermore, components of the control node 10, each designated with symbols “a”, “b”, “c”, and “d” correspond to components included in the control node 10a, the control node 10b, the control node 10c, and the control node 10d, respectively.

For example, the control node 10b includes task information 121b, application information 122b, an executing unit 131b, a monitoring unit 132b, a selecting unit 133b, an acquiring unit 134b, a providing unit 135b, a determining unit 136b, and a requesting unit 137b.

Furthermore, the respective components designated with the symbols “a”, “b”, “c”, and “d” have functions equivalent to respective components corresponding to the original symbols. For example, the monitoring unit 132b has a function equivalent to that of the monitoring unit 132.

As illustrated in FIG. 6, first, the control node 10b monitors the load on its own device while executing a task (step S101). In this case, the executing unit 131b executes the task. Moreover, the monitoring unit 132b monitors the load.

The control node 10b continues to execute the task and monitor the load until the load monitored by the monitoring unit 132b exceeds a threshold (step S102: NO).

For example, at step $102, the monitoring unit 132b determines whether the CPU usage rate has exceeded 80% that is determined as a threshold in advance.

When the load monitored by the monitoring unit 132b has exceeded the threshold (step S102: YES), the selecting unit 133b selects a task having the heaviest processing load from among tasks that have not been selected (step S103).

The tasks that have not been selected are tasks that have not been executed out of the tasks included in the task information 121b. Moreover, in the task information 121b, information indicating whether each task is real-time processing or non-real-time processing, and information indicating an estimated value of processing load and whether it has been selected are included. An initial state or a state right after reset is a state in which all of the tasks have not been selected.

The determining unit 136b determines whether the task selected by the selecting unit 133b is real-time processing (step S104).

When the task selected by the selecting unit 133b is real-time processing (step $104: YES), the acquiring unit 134b acquires information indicating a load on the other control node (step S105). Moreover, the acquiring unit 134b determines whether the task selected by the selecting unit 133b is executable for other control nodes based on the acquired information (step S106).

Moreover, the acquiring unit 134b may acquire, designating the other control node for the task selected by the selecting unit 133b, information indicating whether the task can be executed by the other control node. The acquiring unit 134b may use any method as long as information indicating whether the other control node can execute the task can be acquired.

For example, the acquiring unit 134b acquires information indicating whether the control node 10c can execute the task. Moreover, in this case, a providing unit 135c of the control node 10c provides information indicating a load on the control node 10c or indicating whether the task can be executed by the control node 10c to the acquiring unit 134b.

Furthermore, whether the task can be executed by the control node 10c may be determined according to an estimated value of processing load for each task, and a magnitude of the load on the control node 10c.

When the control node 10c can execute the task selected by the selecting unit 133b (step S107: YES), the requesting unit 137b requests execution of the task to the control node 10c (step S109). The control node 10b then proceeds to step S111.

At step S107, when the control node 10c cannot execute the task selected by the selecting unit 133b (step S107; NO), if there is a task that has not been selected (step S108: YES), the control node 10b returns to step S103 and repeats the processing.

When it is return to step S103 and the processing is repeated, a magnitude of processing load of a task to be selected at step S103 next is equal to or smaller than the processing load of the task selected previously. Therefore, each time the processing is repeated, the possibility of being determined as executable at step S107 increases.

If there is no task that has not been selected (step S108: NO), the control node 10b proceeds to step S111. In this case, the control node 10b executes the task.

Moreover, at step S104, when the task selected by the selecting unit 133b is not real-time processing (when it is non-real-time processing) (step S104: NO), the requesting unit 137b requests the server 30 to execute the task (step S110), and proceeds to step S111.

At step S111, the control node 10b resets selecting state of tasks, returns to step S101, and repeats the processing.

When the magnitude of the load exceeds a threshold as a result of executing the requested task, an additional different server, a cloud environment, and the like can be scaled out to increase resources for executing the task.

At step S104, the determining unit 136 may determine whether the task is real-time processing based on a cycle in which the task is executed. That is, the determining unit 136 determines whether a condition that a period of the execution cycle of the task selected by the selecting unit 133 is equal to or shorter than a threshold (for example, 1 second). Thus, it becomes possible to execute a task expected to be executed in real-time having a short execution cycle (period is equal to or shorter than the threshold) by the control node 10.

Furthermore, the condition that it is real-time execution at step S104 is one example of a condition to determine whether to request the control node 10 or to request the server 30 to execute the task. The determining unit 136 may determine whether to request the control node 10 or to request the server 30 to execute the task based on an arithmetic capacity required for the task instead of necessity of the task to be executed in real time. For example, the determining unit 136 determines whether a condition that the arithmetic capacity required for execution of the task selected by the selecting unit 133 is equal to or lower than a threshold is satisfied. The arithmetic capacity is, for example, a CPU clock frequency. In this case, a task that takes time if it is executed by the control node 10 can be requested to the server 30 to execute it.

Alternatively, the determining unit 136 may determine to request the control node 10 to execute a task executable only with data acquired from the field device 20, and to request the server 30 to execute a task requiring data other than the data acquired from the field device 20.

### Effects

As explained so far, the control node 10 includes the executing unit 131, the selecting unit 133, the determining unit 136, and the requesting unit 137. The executing unit 131 executes an assigned task. The selecting unit 133 selects either one of assigned tasks when a magnitude of load on its own device exceeds a threshold. The determining unit 136 determines whether the task selected by the selecting unit 133 satisfies a condition. The requesting unit 137 requests a first device to execute the task when the task satisfies the condition, and requests a second device to execute the task when the task does not satisfy the condition.

As described, by appropriately requesting another device to execute a task according to a load, it is possible to prevent a control node of a DCS (distributed control system 1) from becoming overloaded.

Moreover, the control nodes 10 store an application program. The executing unit 131 executes a task that is assigned thereto and that includes an operation according to the program. By thus configuring that a common application can be executed by the multiple control nodes 10, execution of a task can be requested thereto easily.

When a control node that is requested to execute a task does not store the application program for executing the task, transmission and reception of data of the entire application (container) including the program between control nodes are necessary at the time of request. In this case, it takes time for transmission and reception of the data, and there is an issue that processing can be suspended in some cases. According to the present embodiment, such a problem can be solved.

### System

The processing procedure, the control procedure, the specific names and the information including various kinds of data and parameters described in the above document and the drawings can be arbitrarily changed unless otherwise specified.

Moreover, the respective components of the respective devices illustrated are of functional concept, and it is not necessarily required to be configured physically as illustrated. That is, specific forms of distribution and integration of the respective devices are not limited to the ones illustrated. Specifically, all or some thereof can be configured to be distributed or integrated functionally or physically in arbitrary units according to various kinds of loads, usage conditions, and the like.

Furthermore, as for the respective processing functions performed by the respective devices, all or an arbitrary part thereof can be implemented by a CPU and a computer program that is analyzed and executed by the CPU, or can be implemented as hardware by wired logic.

### Hardware

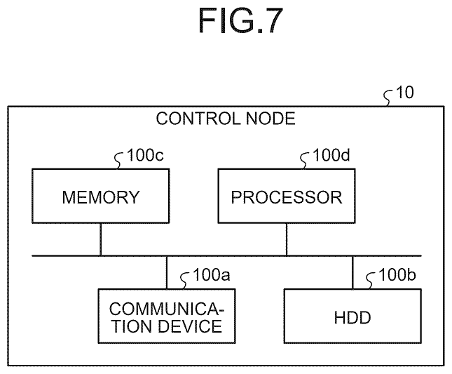

Next, a configuration example of hardware of the control node 10 will be explained. FIG. 7 is a diagram explaining a hardware configuration example. As illustrated in FIG. 7, the control node 10 includes a communication device 100a, a hard disk drive (HDD) 100b, a memory 100c, and a processor 100d. Moreover, the respective components illustrated in FIG. 7 are connected to one another through a bus or the like.

The communication device 100a is a network interface card or the like, and performs communication with other servers. The HDD 100b stores a program to implement the functions illustrated in FIG. 2 and a DB.

The processor 100d reads the program that implements processing similar to that of the respective processing units illustrated in FIG. 2 from the HDD 100b or the like and expands it to the memory 100c, to thereby operate processes to implement the respective functions explained in FIG. 2 and the like. For example, this process performs functions similar to those of the respective processing units included in the control node 10. Specifically, the processor 100d reads out a program having functions similar to those of the executing unit 131, the monitoring unit 132, the selecting unit 133, the acquiring unit 134, the providing unit 135, the determining unit 136, and the requesting unit 137, from the HDD 100b or the like. The processor 100d performs the process to perform the processing similar to that of the executing unit 131, the monitoring unit 132, the selecting unit 133, the acquiring unit 134, the providing unit 135, the determining unit 136, and the requesting unit 137.

As described, the control node 10 operates as the information processing apparatus that performs the information processing method by reading and executing the program. Moreover, the control node 10 can implement functions similar to the embodiment described above by reading the program described above from a recording medium by a medium reader device, and by executing the read program described above also. Programs in other embodiments are not limited to be executed by the control node 10. For example, the present invention can be applied similarly also to a case in which the program is executed by other computers or servers, or a case in which the program is executed by these in cooperation.

This program can be distributed through a network such as the Internet. Furthermore, this program can be recorded on a computer-readable recording medium, such as a hard disk, a flexible disk (FD), a compact-disk read-only memory (CD-ROM), a magneto optical disk (MO), and a digital versatile disk (DVD), and can be executed by being read by a computer from the recording medium.

Some examples of combinations of the disclosed technical features are described in the following.
(1)

A distributed control system comprising:
a plurality of control nodes that are connected to one another; and
a server that is connected to the control nodes, wherein
each of the control nodes includes
   an executing unit configured to execute an assigned task;
a selecting unit configured to select either one of assigned tasks when a magnitude of a load on its own device exceeds a threshold;
a determining unit configured to determine whether the task selected by the selecting unit is real-time processing ; and
a requesting unit configured to request either one of the plurality of control nodes other than the control node itself to execute the task when the determining unit determined that the task is real-time processing, and to request the server to execute the task when the determining unit determined that the task is not real-time processing.
(2)

The distributed control system according to (1), wherein
the control nodes store an application program, and
the executing unit executes a task that is an assigned task and that includes an operation according to the program.
(3)

The information processing apparatus according to (1) or (2), wherein
the determining unit determines that the task is real-time processing when a period of execution cycle of the task selected by the selecting unit is equal to or shorter than a threshold.
(4)

The information processing apparatus according to (1) or (2), wherein
the determining unit determines that the task is real-time processing when an arithmetic capacity required for the task selected by the selecting unit is equal to or lower than a threshold.

### REFERENCE SIGNS LIST

1 Distributed Control System
10, 10a, 10b, 10c, 10d Control Node
11, 31 Communication Unit
12, 32 Storage Unit
13, 33 Control Unit
20, 21a, 22a, 21b, 22b, 21c Field Device
30 Server
100a Communication Device
100b HDD
100c Memory
100d Processor
121 Task Information
122, 322 Application Information
131, 331 Executing Unit
132 Monitoring Unit
133 Selecting Unit
134 Acquiring Unit
135 Providing Unit
136 Determining Unit
137 Requesting Unit

1. An information processing apparatus of one of a plurality of control nodes comprising:
a processor configured to:
an execute an assigned task;
select either one of assigned tasks when a magnitude of a load on the information processing apparatus exceeds a threshold;
determine whether the task selected is real-time processing; and request either one of the plurality of control nodes other than the information processing apparatus to execute the task when the task is determined to be real-time processing, and to request a server to execute the task when the task is determined to be not real-time processing.

2. The information processing apparatus according to claim 1, wherein
the processor is configured to
determine that the task is real-time processing when a period of execution cycle of the task selected is equal to or shorter than a threshold.

3. The information processing apparatus according to claim 1, wherein
the processor is configured to
determine that the task is real-time processing when an arithmetic capacity required for the task selected is equal to or lower than a threshold.

4. An information processing method that is performed by a computer of one of a plurality of control nodes, the computer performing processing of:
executing an assigned task;
selecting either one of assigned tasks when a magnitude of a load on the computer exceeds a threshold;
determining whether the selected task is real-time processing; and
requesting either one of the plurality of control nodes other than the computer to execute the task when the determining unit determined that the task is real-time processing, and requesting a server to execute the task when the determining unit determined that the task is not real-time processing.

5. A non-transitory computer-readable recording medium having stored therein a program that causes a computer of one of a plurality of control nodes to execute a process comprising:
executing an assigned task;
selecting either one of assigned tasks when a magnitude of a load on the computer exceeds a threshold;
determining whether the selected task is real-time processing; and
requesting either one of the plurality of control nodes other than the computer to execute the task when the determining determined that the task is real-time processing, and requesting a server to execute the task when the determining determined that the task is not real-time processing.

6. (canceled)

7. (canceled)
